(19) United States
(12) Patent Application Publication
(10) Pub. No.: US 2008/0104504 A1
(43) Pub. Date: May 1, 2008

(54) METHOD OF CONTROLLING CONSTRUCTION OF A MACHINE-READABLE DOCUMENT

(75) Inventors: Roger Brian Gimson, Bristol (GB); Robert Thomas Owen Rees, Newport (GB); John William Lumley, Bristol (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: HEWLETT-PACKARD DEVELOPMENT COMPANY, L.P., Houston, TX (US)

(21) Appl. No.: 11/926,561

(22) Filed: Oct. 29, 2007

(30) Foreign Application Priority Data
Oct. 30, 2006 (GB) 0621468.8

(51) Int. Cl. G06F 3/14

(52) U.S. Cl. 715/234

(57) ABSTRACT

A method of controlling construction, at a remote source, of a machine-readable document is described. The method comprises the steps of presenting a view of a machine-readable document template stored at the remote source and having static and dynamic portions, the dynamic portions being processable in conjunction with a variable data machine-readable document to construct an output machine-readable document. The method further comprises the steps of presenting a view of a variable data machine-readable document stored at the remote source, adding at least one data field to the variable data document, populating the further data field with data and sending an instruction to the remote source to modify the machine-readable document template to include a dynamic portion corresponding to the further data field.

### FIELD OF THE INVENTION

The invention relates to a method of controlling construction of a machine-readable document.

### BACKGROUND OF THE INVENTION

One method for constructing a machine-readable document is described in the document “Method of Processing a Publishable Document” filed as U.S. Ser. No. 11/400,991 on 10 Apr. 2006 which is commonly assigned herewith and incorporate d herein by reference. According to this approach a machine-readable document, that is a machine-readable representation processable to provide an output such as a user viewable document, is treated as a programme which can be compiled and executed to create a further machine-readable document for example by binding it with variable data. The further machine-readable document can be processed to create a user viewable document or can be further compiled and executed for example with additional variable data to create yet a further machine-readable document. The machine-readable document is processed by an “observer” to create the user viewable document in the form, for example of a PDF document.

### BRIEF SUMMARY OF THE INVENTION

A method of controlling construction, at a remote source, of a machine-readable document is described. The method comprises the steps of presenting a view of a machine-readable document template stored at the remote source and having static and dynamic portions, the dynamic portions being processable in conjunction with a variable data machine-readable document to construct an output machine-readable document. The method further comprises the steps of presenting a view of a variable data machine-readable document stored at the remote source, adding at least one data field to the variable data document, populating the further data field with data and sending an instruction to the remote source to modify the machine-readable document template to include a dynamic portion corresponding to the further data field.

### BRIEF DESCRIPTION OF THE INVENTION

Embodiments of the invention will be described, by way of example, with reference to the drawings, of which:

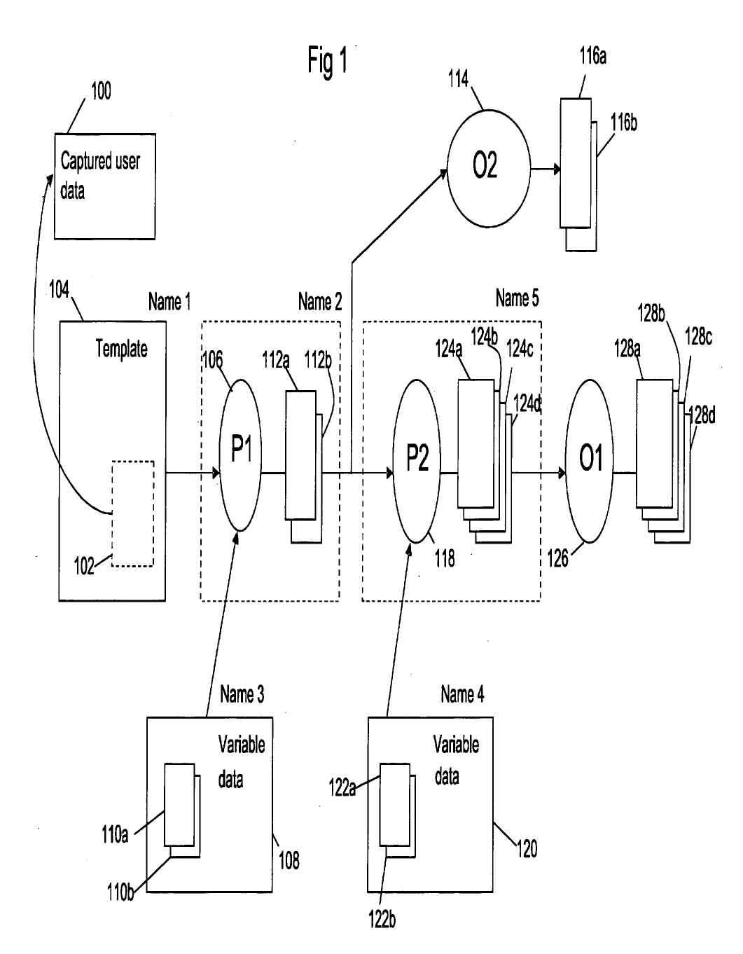

FIG. 1 is a block diagram showing in overview an example of implementation of various aspects of the approach;

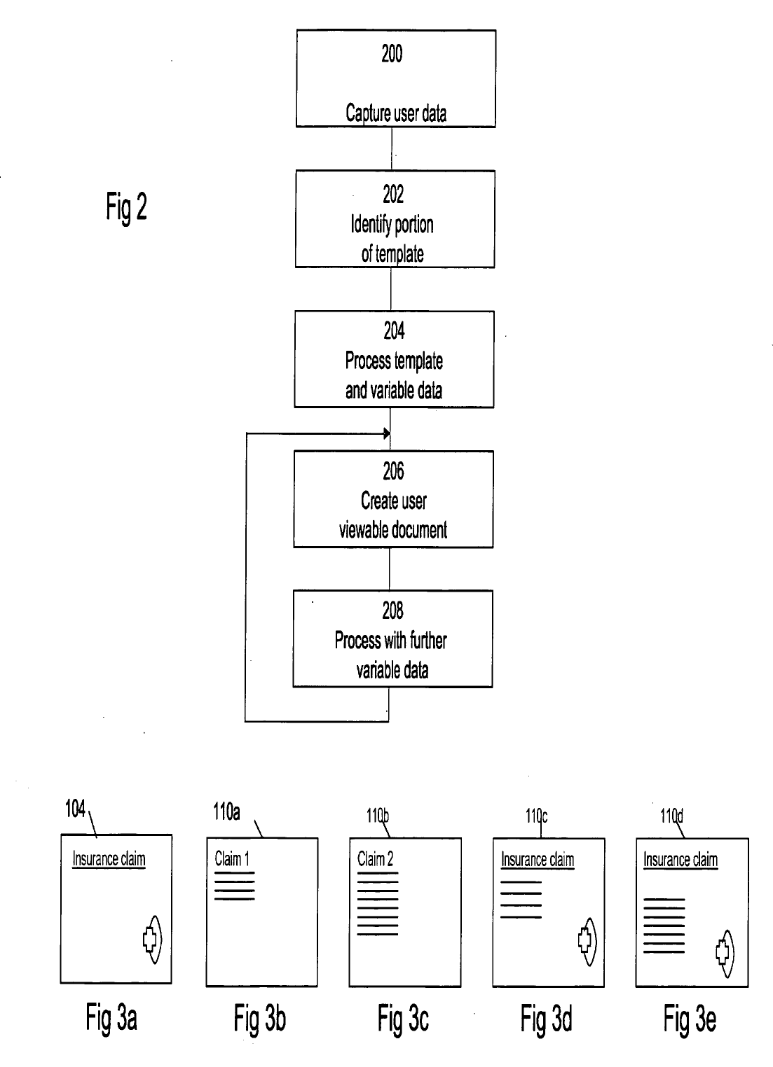

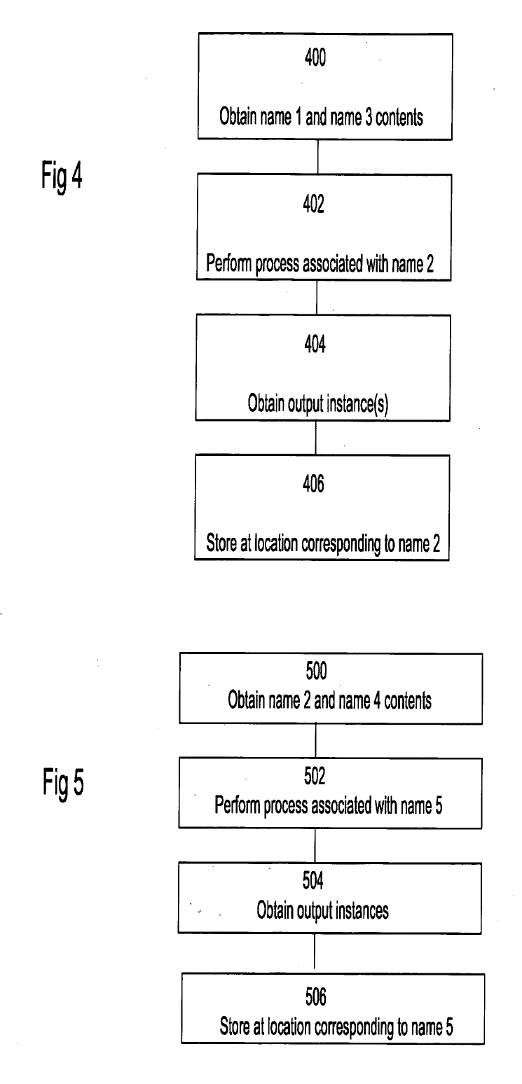

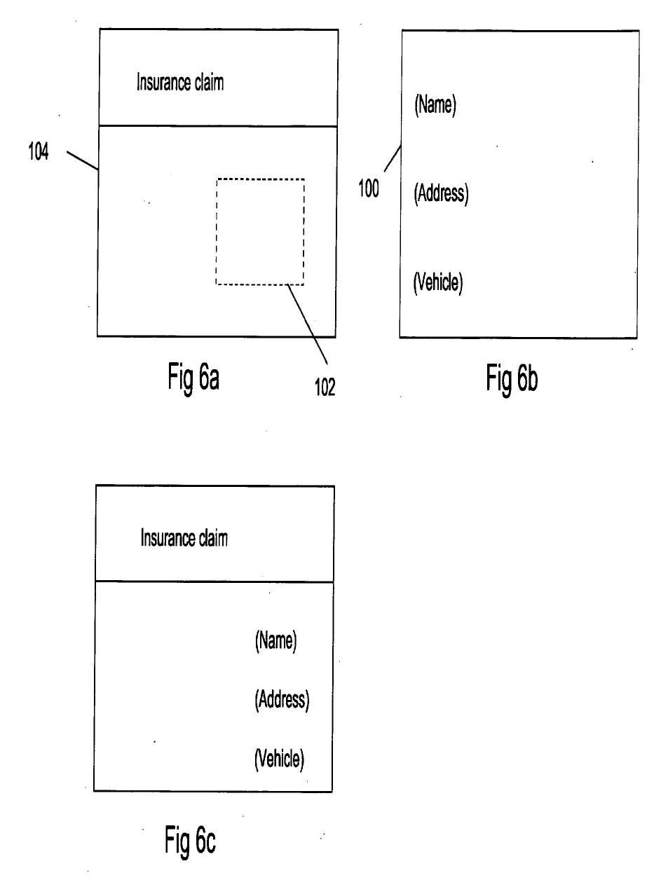

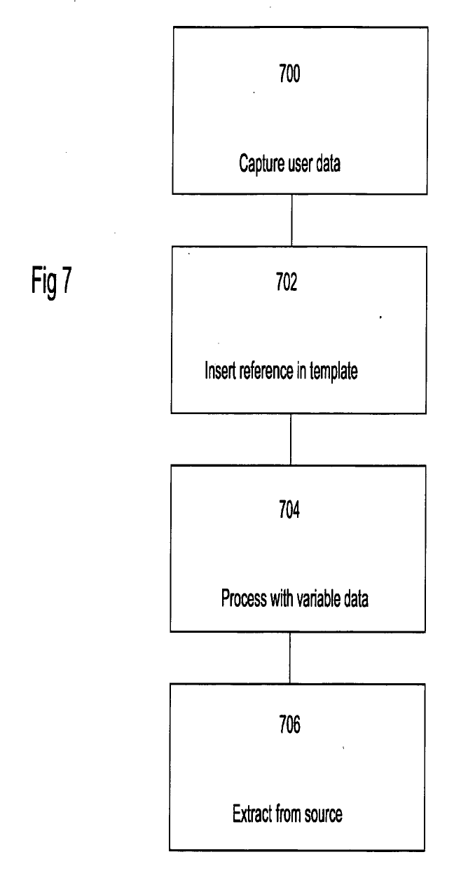

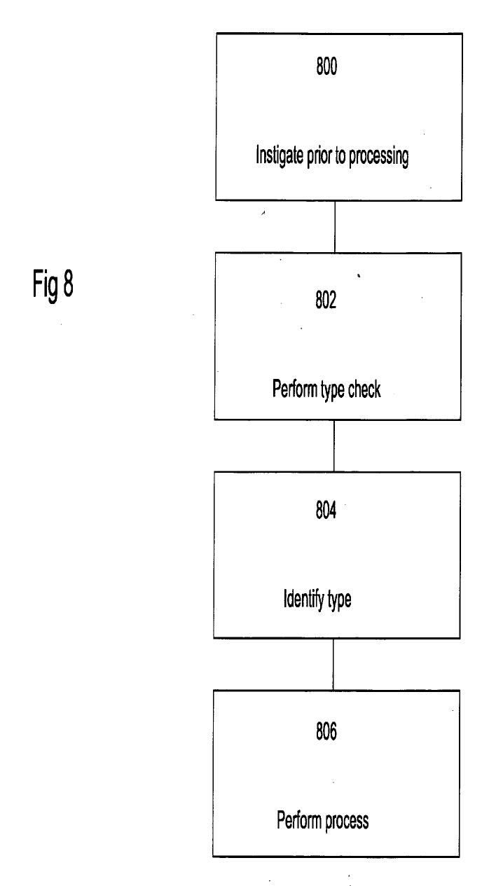

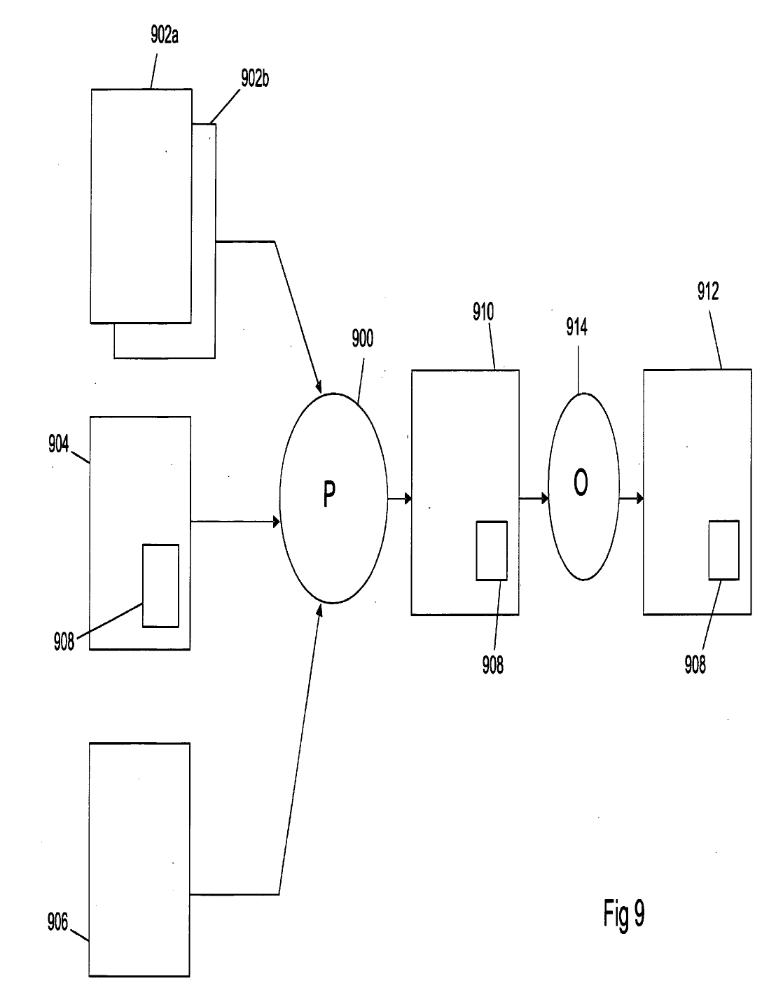

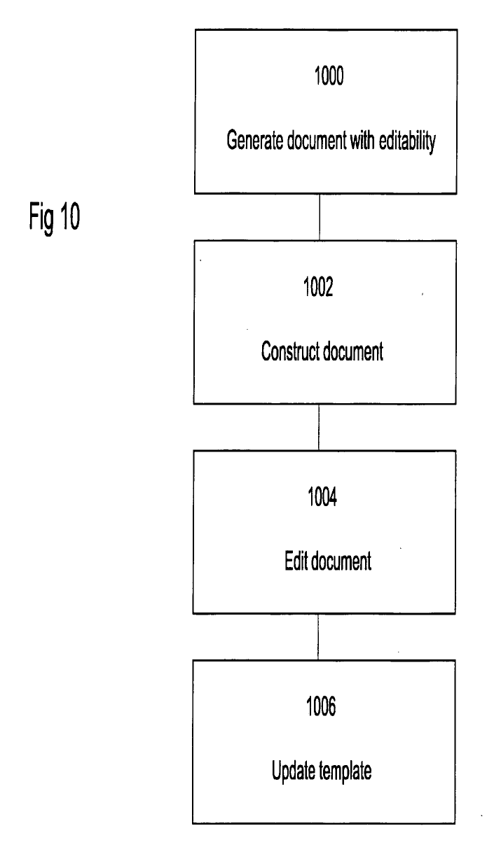

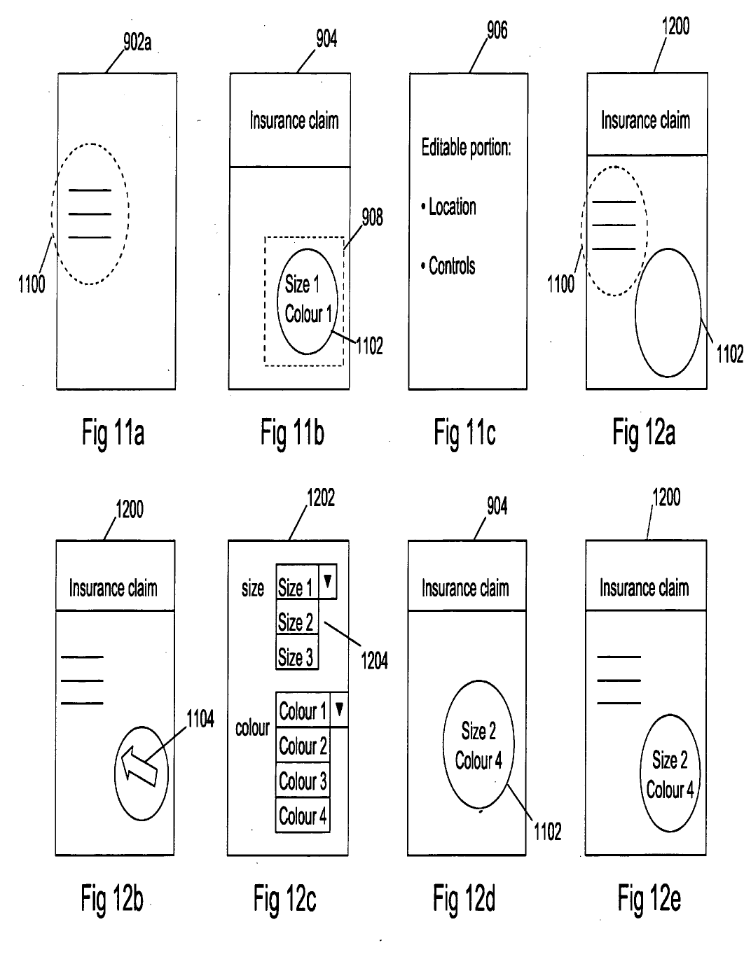

FIG. 2 is a flow diagram showing the steps involved in processing the example of FIG. 1;

FIG. 3a shows a sample input document to the example of FIG. 1;

FIG. 3b shows a sample input document to the example of FIG. 1;

FIG. 3c shows a sample input document to the example of FIG. 1;

FIG. 3d shows a sample output document combining the documents of FIG. 3a and FIG. 3b;

FIG. 3e shows a sample output document combining the input documents of FIG. 3a and FIG. 3c;

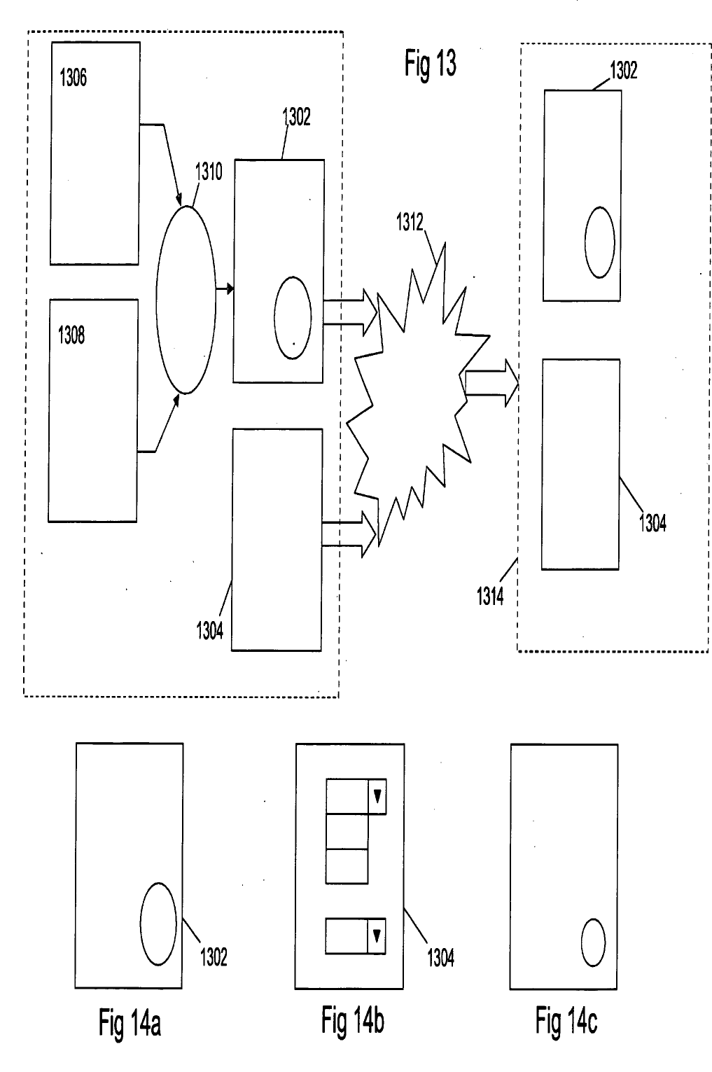

FIG. 4 is a flow diagram showing in overview steps involved according to a first aspect of the approach described herein;

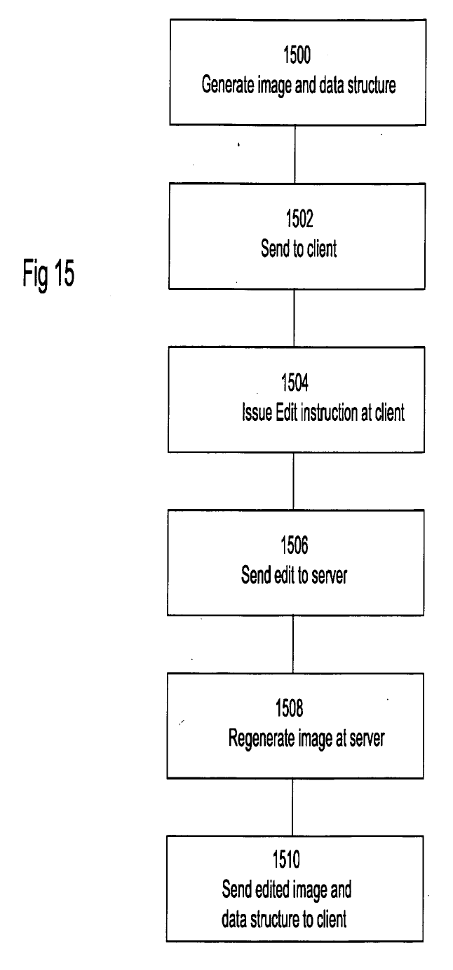

FIG. 5 is a flow diagram showing further steps involved in the first aspect;

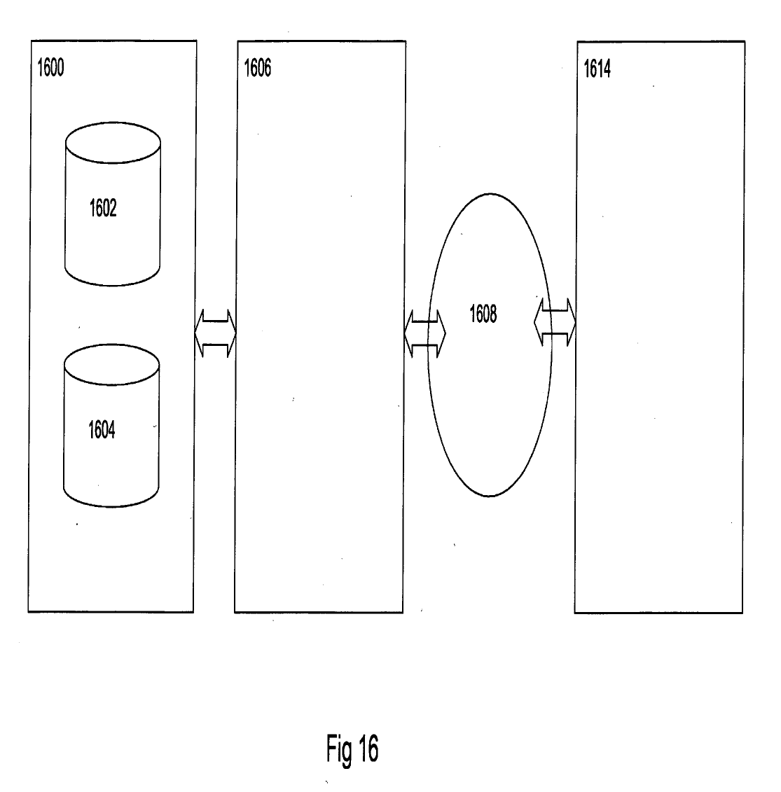

FIG. 6a shows a sample input document according to a second aspect of the present approach;

FIG. 6b shows a further sample input document according to the second aspect;

FIG. 6c shows an output document created from the input documents of FIGS. 6a and 6b according to the second aspect;

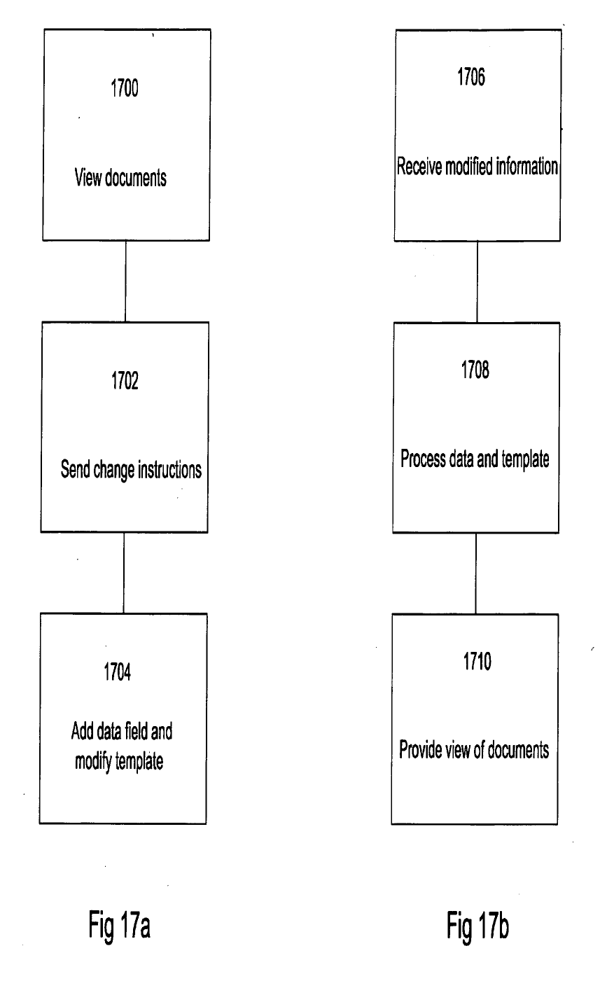

FIG. 7 is a flow diagram showing in overview steps involved in implementing the second aspect;

FIG. 8 is a flow diagram showing in overview steps involved according to a third aspect of the present approach;

FIG. 9 is a block diagram showing in overview an example of implementation of a fourth aspect of the present approach;

FIG. 10 is a flow diagram showing steps involved in implementing the fourth aspect;

FIG. 11a shows a sample input document for use according to the fourth aspect;

FIG. 11b shows a further sample input document for use according to the fourth aspect;

FIG. 11c shows a further sample input document for use according to the fourth aspect;

FIG. 12a shows a sample output document generated according to the fourth aspect;

FIG. 12b shows an editing step applied to the output document of FIG. 12a;

FIG. 12c shows edit controls displayed according to the fourth aspect

FIG. 12d shows a revised input document according to the fourth aspect;

FIG. 12e shows a revised output document according to the fourth aspect;

FIG. 13 is a block diagram showing in overview an example of implementation of a fifth aspect of the present approach;

FIG. 14a shows an example editable document image according to the fifth aspect;

FIG. 14b shows edit controls for the document of FIG. 14a;

FIG. 14c shows an edited document;

FIG. 15 is a flow diagram showing the steps involved in implementing the fifth aspect;

FIG. 16 is a block diagram showing in overview an example of implementation of a sixth aspect of the present approach

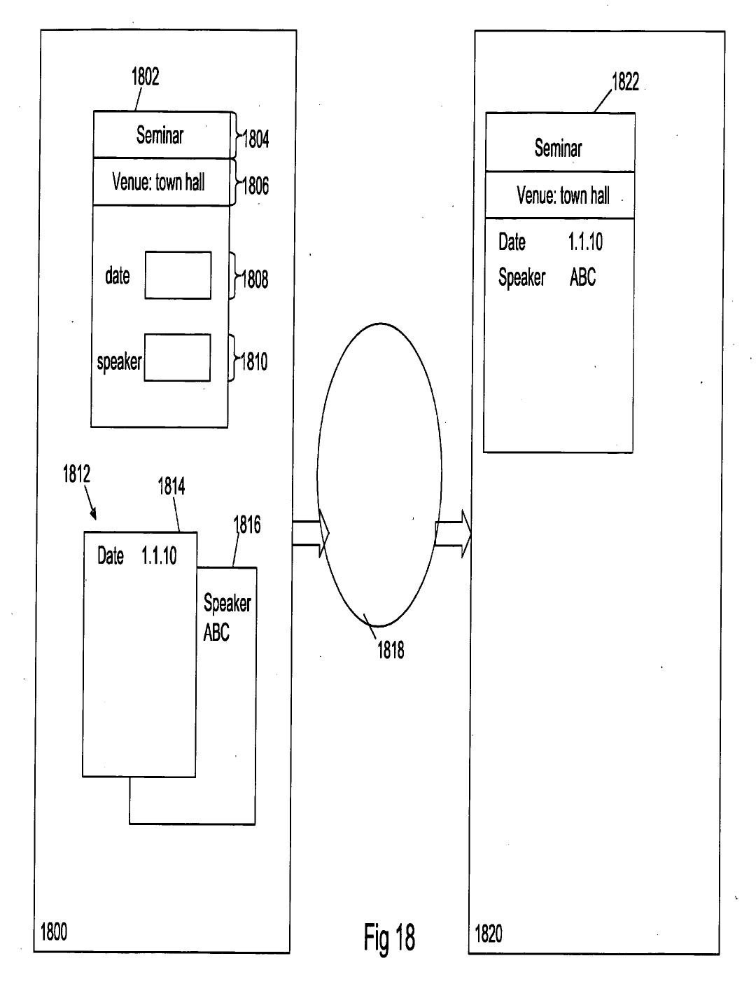

FIG. 17a is a flow diagram showing in overview the steps involved in implementing a sixth aspect of the present approach at a client location;

FIG. 17b is a flow diagram showing the steps involved in implementing the sixth aspect at a server location;

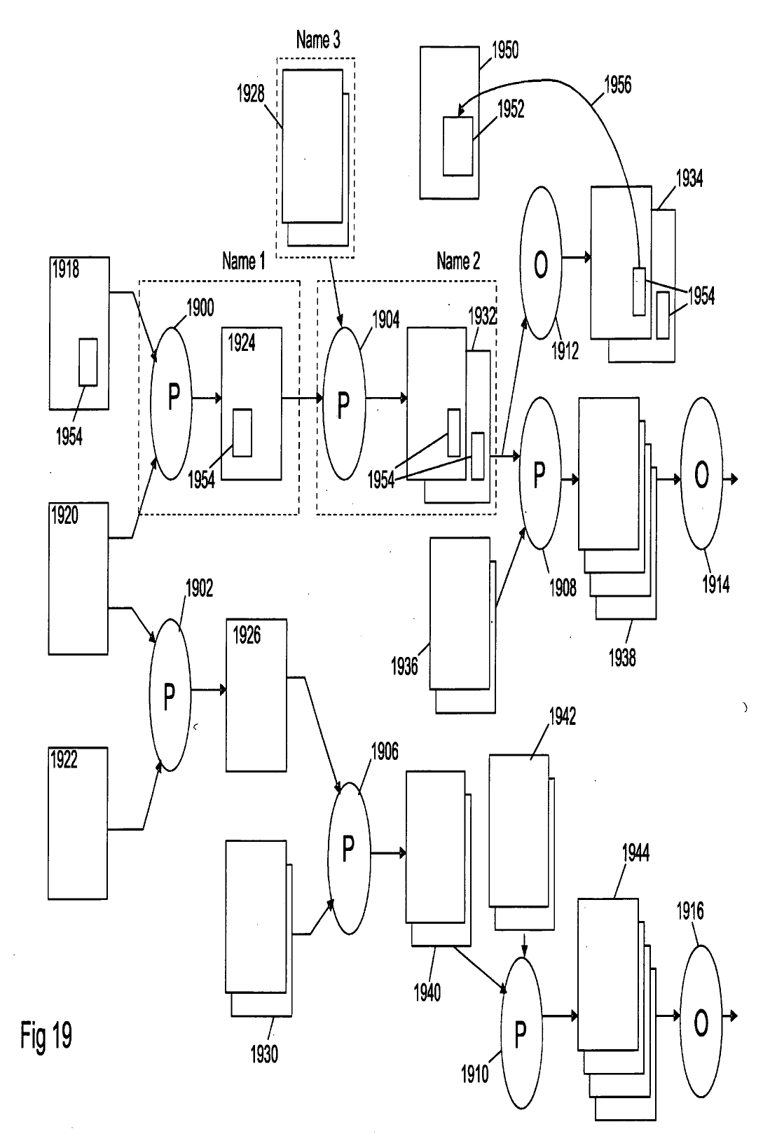

FIG. 18 is a block diagram showing an example of implementation of the sixth aspect;

FIG. 19 is a block diagram showing in more detail an example of implementation of various aspects of the approach;

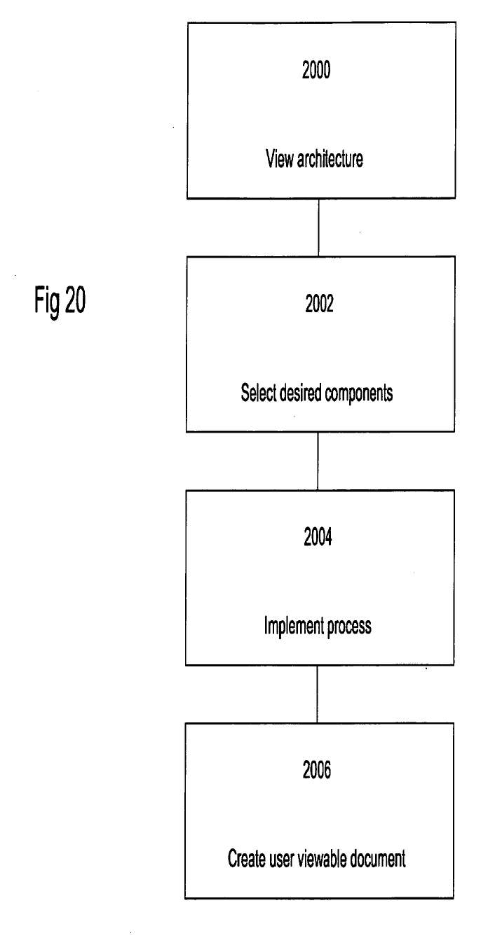

FIG. 20 is a flow diagram showing in more detail steps involved in implementing the first approach;

FIG. 21 is a flow diagram showing in more details steps involved in implementing the second aspect;

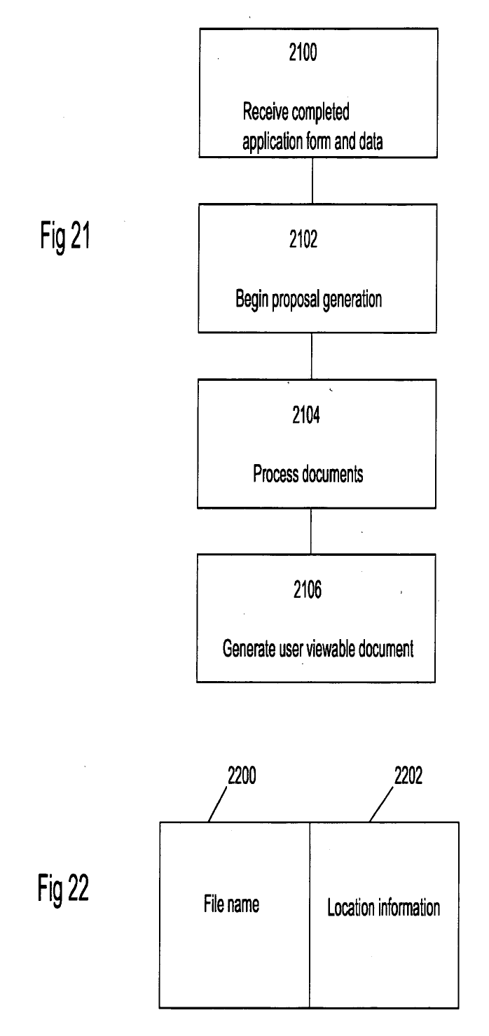

FIG. 22 is a diagram illustrating schematically a resource indicator according to the second aspect;

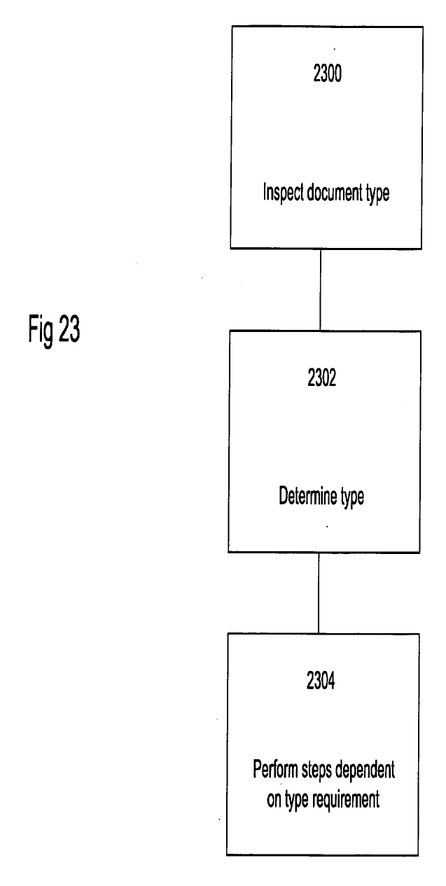

FIG. 23 is a flow diagram showing in more detail steps involved in implementing the third aspect;

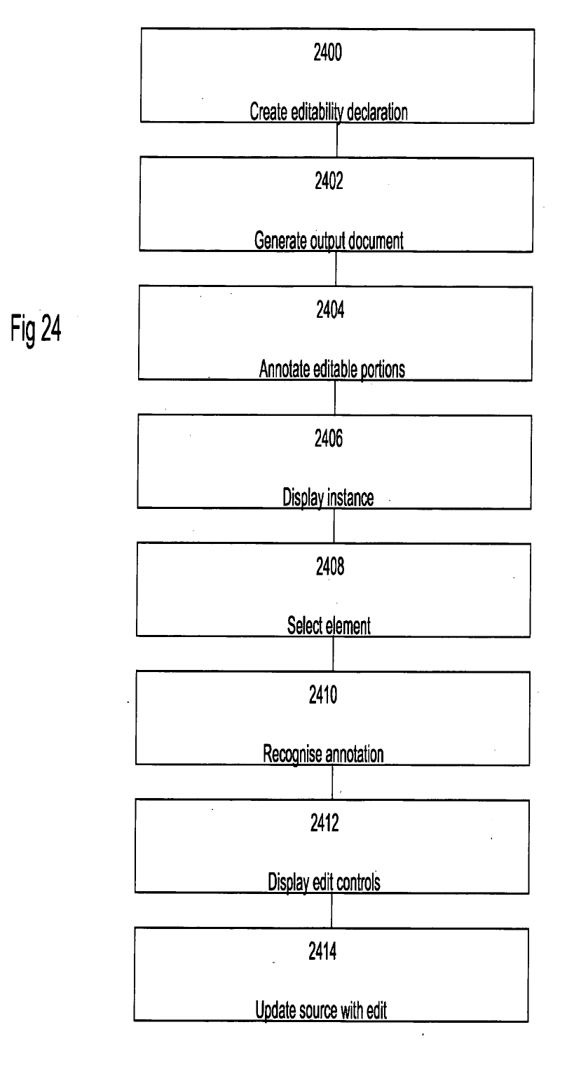

FIG. 24 is a flow diagram showing in more detail steps involved in implementing the fourth aspect;

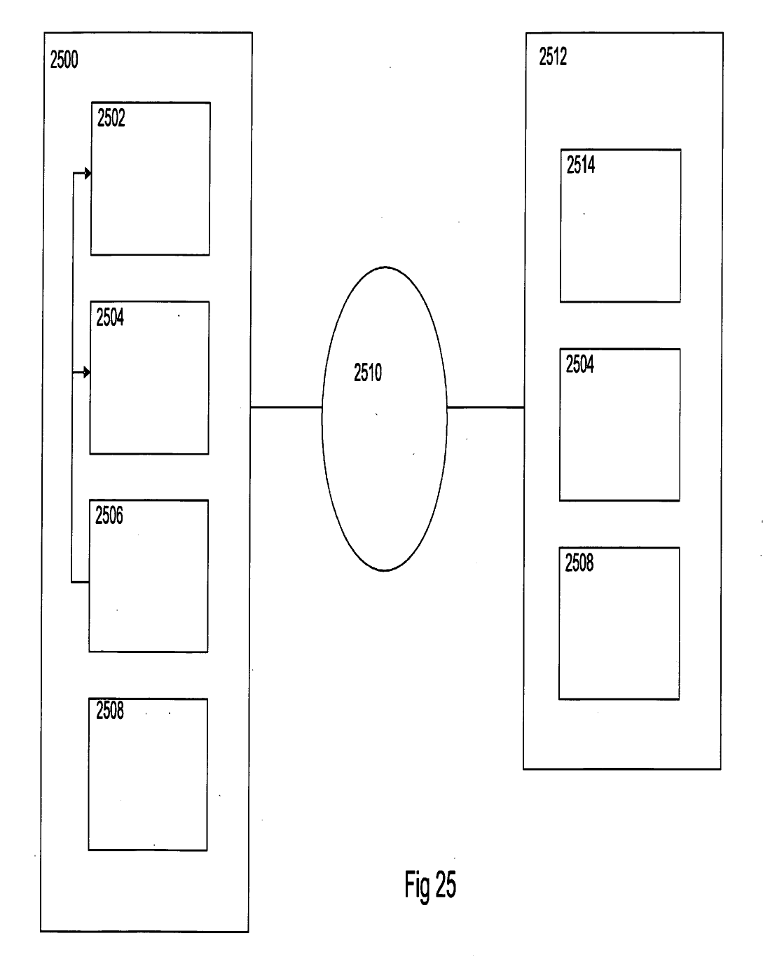

FIG. 25 is a block diagram showing in more detail implementation of the fifth aspect;

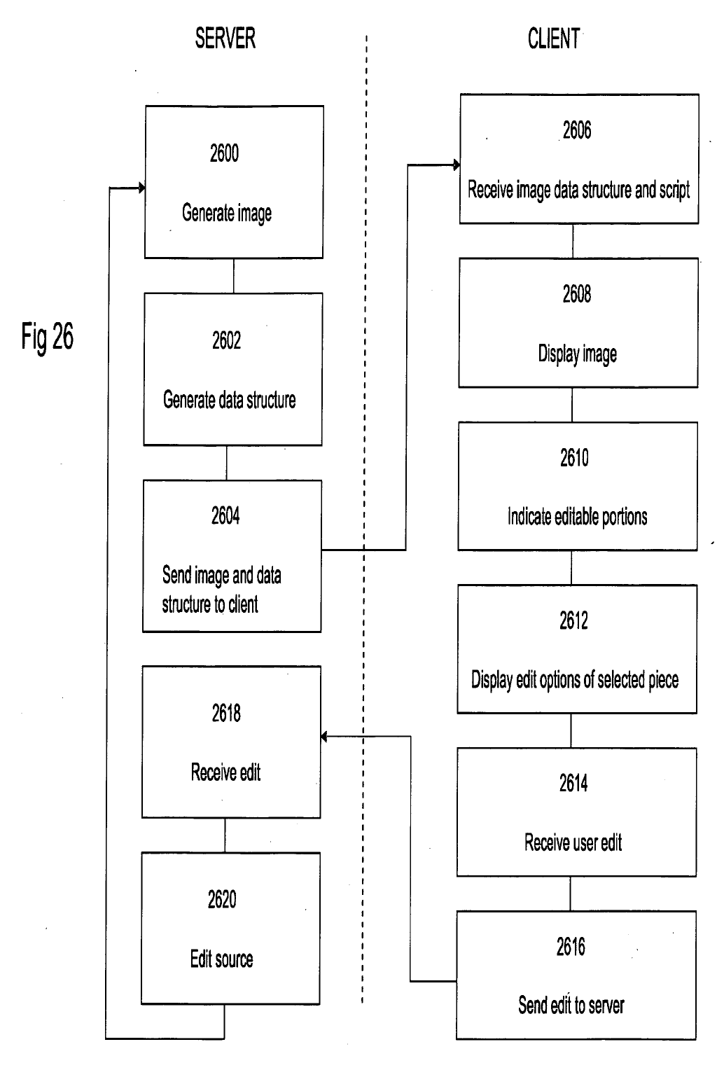

FIG. 26 is a flow diagram showing in more detail the steps involved in implementing the fifth aspect;

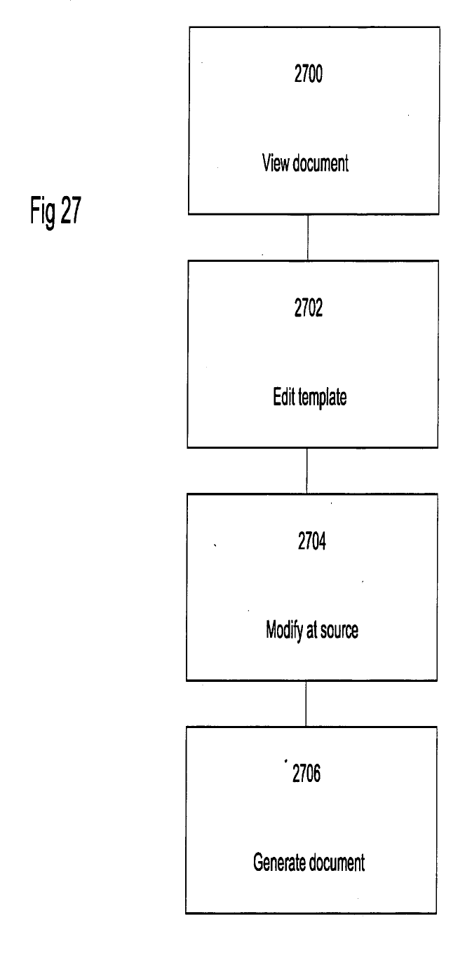

FIG. 27 is a flow diagram showing in more detail the steps involved in implementing the sixth aspect; and

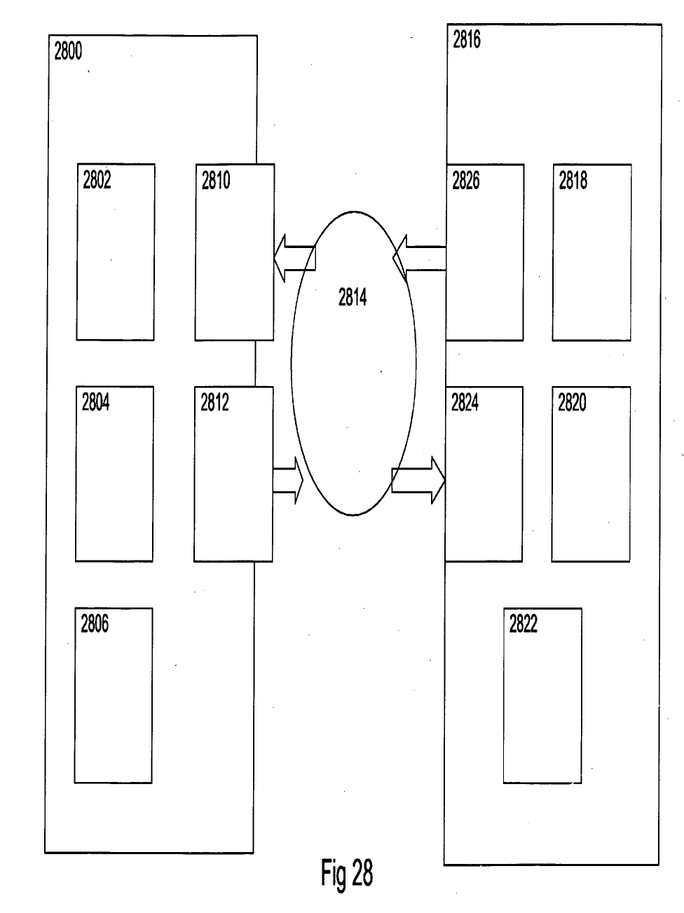

FIG. 28 is a block diagram illustrating a computer architecture by which the various aspects can be implemented.

### DETAILED DESCRIPTION OF THE INVENTION

The method and apparatus described herein comprise various aspects which are first described in overview below. Various aspects of the approach can be implemented separately and independently of one another or two or more of the approaches can be implemented in conjunction with one another as appropriate. In the case that each aspect is separately and independently implemented any alternative additional implementation approach can be adopted as appropriate and indicated below.

Various of the aspects can understood with reference to an example of constructing machine-readable documents described with reference to the exemplary scenario illustrated in FIG. 1 and the corresponding steps of the flow diagram of FIG. 2.

The scenario relates to construction of a machine-readable document comprising an insurance document which includes both captured user data and variable data for example relating to specific insurance claims or a specific local insurance agent responsible for policy, together with a template document for insurance claims from an insurance company to whom the local agent belongs.

At step 200 in FIG. 2, therefore, user data 100 is captured in the form, for example, of name, address or other identifying data and this is stored at a source location 100. At step 202 the corresponding portion 102 of a template document 104 at which the captured user data should appear includes a reference to the captured user data 100. The template claim form 104 comprises a machine-readable input document with a user detail space allowing reuse for any user. The reference portion 102 includes for example identification of the location and identity of the relevant data portion.

At step 204 a process P1 indicated as 106 in FIG. 1 is applied to the template machine-readable document 104 together with a machine-readable input document comprising variable data 108 to be bound to the template in an interpolation step. The variable data 108, in the present example, comprises details of the insurance claim specific to the insuree. It may, for example, comprise multiple instances 110a, 110b relating to separate claims from the same insuree. In that case as will be seen the output of the process comprises two respective machine-readable output documents 112a, 112b carrying the template data, the reference to the captured user data and each instance of the variable data 110a, 110b. This output document itself comprises a machine-readable document which can be treated as an input document, processable to provide yet further output machine-readable documents or may be converted to a user viewable document as appropriate.

Accordingly at step 206 in one approach, if there is no further variable data to be bound then the process proceeds to an “observer” O2, 114 which processes the machine-readable documents to provide user viewable documents 116a, 116b which can then be user viewed for example on a computer screen or printed out as appropriate.

Alternatively, at step 208, the machine-readable documents 112a, 112b may be further processed by a processor P2, 118 in conjunction with yet further variable data 120. The variable data 120 may also contain multiple instances for example instances 122a, 122b comprising terms and conditions and details of the specific office selling the policy respectively, or for example style of data governing the style of the document. In this case the output machine-readable document will include multiple instances 124 a to d representing the various possible combinations of the two dual inputs to process P2. The process can then turn to step 206 to create a user viewable document albeit with a further observer O1, 126 to create documents 128 a to d. It will be seen therefore that different user viewable documents can be created at different stages. For example observer O2 can be applied if there are no local agent or terms and conditions information to be incorporated, but if the additional information is required then further processing can be provided as well. It will further be noted that observers O1 and O2 can create different types of user viewable documents as appropriate.

Turning now specifically to the first aspect in overview, a modular variable document architecture of the type shown in FIG. 1 is provided where documents are composed from other documents and the parts may be reused to make a number of different documents for example in the form of the various possible different output documents described above. The documents can have variants based on input data and the approach provides a way to define which pieces go to make up each document and over what data the variants can be instantiated. As a result the description can be input to a tool allowing generation of selected output documents and which can identify outputs or input documents that have already been generated and hence do not need to be generated again.

The sets of input documents and data required to generate variable documents are defined in a machine processable form corresponding to the architecture shown in FIG. 1. This form supports both the automation of the process that generates the documents and the visualisation of the way in which the documents are constructed. Because work does not need to be duplicated where documents have already been generated, it becomes feasible to generate selected documents on demand from a potentially very large set of possible documents speedily and efficiently.

In particular a further document can be generated in machine-readable form which describes the components of the operation including data, templates and processes in a manner analogous to the visually represented architecture of FIG. 1.

For example with reference to FIG. 3a to 3e, a machine-readable document can be constructed by applying a machine-readable document construction process such as process P1, reference numeral 106, in FIG. 1 to first and second input machine-readable documents comprising a template 104 (FIG. 3a) and at least one of variable data instances 110a, 110b including different insurance claim details. As can be seen in FIG. 3, the insurance claim template may comprise, for example, a simple document with the heading “Insurance Claim” together with the logo of the insurance company, although any appropriate information can of course be included. The claim data may comprise text or data retrieved from forms filled in on-line or any other appropriate claim data. The template 104 and instances of variable data 110a, 110b are combined to create output documents 112a, 112b as shown in FIG. 3d and FIG. 3e respectively in which it will be seen that different variable data is incorporated for the different instances. This document can then be processed by the Observer to create the user viewable forms.

According to the approach of the first aspect it is then necessary to ensure that the output machine-readable documents can be identified within the overall process shown in FIG. 1 and that unnecessary processing can be avoided. In particular this is achieved by storing the content of the output machine-readable documents (for example documents 110c, 110d) at a storage location and assigning an identifier to the output machine-readable document identifying the storage location. The identifier can also include reference to the inputs to the process P1 which created the output document, those inputs being template 104 and variable data 108, hence allowing identification of the documents from which the output document was constructed.

For example referring once again to FIG. 1, template 104 is assigned an identifier “name 1”, variable data 108 is assigned “name 3” and process P1, 106 and outputs 112a and 112b are assigned identifier “name 2”.

Hence the description associates output documents 112a and 112b with process P1 and its inputs name 1, name 3 all by virtue of the identifier name 2, hence indicating what inputs created the output documents and what process was applied to them.

When it is desired to construct the output documents having name 2, process P1 is performed as shown in FIG. 4. At step 400 process P1 obtains the contents of the relevant input documents identified by names 1 and 3. It will be noted that there may be multiple versions where there are multiple data instances, for example name 3 in fact relates to two data instances, 110a, 110b.

At step 402 the process defined in conjunction with name 2, ie process P1 is performed, for example binding the instances of the data 110a, 110b to the template 104. At step 404 the two output instances 112a, 112b are obtained and at step 406 the contents are stored at a location corresponding to the identifier name 2. Where there are multiple instances then the step may include adding tags as qualifiers to each instance. A time stamp is also applied to the or each instance to indicate when the document was created.

As a result the selection of documents to be combined is separated from the content of the documents themselves allowing the documents to be reused in a flexible way as well as simplifying the avoidance of unnecessary processing where the output is already up to date as signified by the time stamp. As each document is described in terms of the process used to generate it and the inputs to that process, the overall sequence of the process can be derived from the individual descriptions, and each document can be considered separately which reduces the complexity of the overall description.

This can be further understood with reference to FIG. 5 which shows how yet further processing might take place for example at P2, reference numeral 118 in FIG. 1. Where additional variable data 120 has identifier name 4 then at step 500 process P2 obtains the contents stored at the location identified within names 2 and 4 as input documents. In both cases it will be seen that two instances are available for each of name 2 and name 4 and these are identified by their respective qualifiers.

At step 502 the input documents are processed by document P2 as described in the associated process description under the corresponding name, name 5. The output instances 124a to 124d are obtained at step 504 and at step 506 are stored at the location corresponding to name 5, again with appropriate qualifiers per instance and any required time stamping.

As discussed above the output documents can be processed by an observer to obtain a user viewable document either at the end of the steps of FIG. 4 or at the end of steps of FIG. 5 depending on what output is required. It will be noted that names 1, 3 and 4, comprising documents but no associated processes or inputs share the syntax of names 2 and 5 but with a “null” process defined therein, and no inputs, such that all of the identifiers name 1 to name 5 perform the same function. Because each of the components is described in modular form, when the process is run each of the components can be examined, for example by accessing the location identified within the name, to see whether it is up to date (for example by examining the time stamp) or indeed has been created at all. If so then there is no need to begin the whole process from the beginning; the up to date documents can be retrieved and reused, simplifying the procedure.

It will be seen that this approach described above in overview provides an improvement over conventional approaches to document modularity according to which parts of documents are included by an “include” directive in an outer document to which the relevant processing is applied, making it difficult to include a different component document in order to generate a different output without editing the outer document.

Turning now to the second aspect in overview, this relates to construction of an instance of a variable-data document incorporating multiple fragments. The second aspect may be performed in conjunction with, or independently of the first aspect. The fragments comprise elements from source documents, such as complete pages (such as covers or sections) or significant components of the documents such as tables, graphs or figures. In particular, the approach allows construction of variable data documents allowing the fragments to be selected as a consequence of binding variable data, and additionally allows decoupling of the act of interpolation of the fragments from the exact mechanism for evaluating the effect of variable data.

This can be further understood with reference to FIGS. 6a to 6c. A template document 104 may comprise a basic, un-populated vehicle insurance claim form which may, for example, have a title “insurance claim” and an extractable portion 102 for insertion of corresponding extractable data such as captured user data 100 providing user name, user address and user vehicle. As discussed in more detail below, when the template is combined for example with variable data 108 and an user viewable document is constructed at observer 114, the finalised output is constructed by extracting the name, address and vehicle information from the captured user data based on a source document locator and extractable portion identifier in the template document which is unaltered by the intermediate processing.

This can be further understood with reference to FIG. 7. At step 700 user data 100 is captured for example from input data to an on-line claim form and stored as a source document or a component thereof. At step 702 a reference to the extractable portion is included in a document such as the template or generatable from some aspect of variable data for the document instance, in the form a source document locator and a fragment reference extractable portion identifier. In particular this allows the entire user source document to be stored as the captured user data and for the required portion only to be identified by the extractable portion identifier.

At step 704 the template 104 is processed with variable data, the extractable portion identifier being declared and passing through any processing steps of the template such that it is unaltered in intermediate documents. The element emerges in the final “output” as required.

At step 706, during final projection of the resulting document into a user viewable document for example a print-ready form such as PDF, the fragment reference is used to determine the portion of the source document required and the data for that fragment is interpolated into the final print-ready form. Any appropriate format conversations can be performed by the Observer.

As a result it is not necessary to incorporate the document fragment itself into the template as a result of which an import action is not required such that interpolation of the data is not required when making an intermediate document instance from a template. Hence, construction of instances of variable—data documents can include components derived or extracted from other source documents through a system of extractable portion identifiers carried through the construction process and only interpolated into final output forms. This makes it possible for fragments to be selected as a consequence of, or directly referenced in variable data, as well as in original construction of the template. Such fragments can be transported through arbitrary programs evaluating the effect of variability on a particular document instance. As a result even where complex intermediate processing steps are involved, processing agents do not need knowledge of the format of a component passing through. This increases the range of potential documents that a given document construction system can produce with minimal alteration to existing processing machinery allowing document fragments to be interpolated via the references embedded in variable document instance data. Furthermore, because the reference is to an external document, and the document is only imported at the final stage, there is no risk of corruption of the document data during the intermediate processing step.

Considering now the third aspect of the present approach in overview, a modular document architecture is supported by composing documents from component parts which are both reusable and replaceable in output documents or compositions. The third aspect may be performed in conjunction with either or both of the first or second aspect or can form a stand-alone approach as appropriate. For ease of explanation however, the following overview discussion is provided in the context of the same example as the first and second aspects.

In order to support a modular document architecture, types are defined that can describe both the parts from which documents are composed and the places in to which they may fit in an output document. As a result a correct fit can be verified for a proposed output document. Document parts that will fit in a given context can be extracted from a collection of document parts and the derivation of the type from the examination of the parts and combination of parts can be automated. Hence, considering the variable data documents as functions, the type system can include both functional and data aspects that an input document makes available to the other fragments or input documents to a composite document as well as the functional and data aspects of other document components that may or must be available to the component.

This can be understood with further reference to FIG. 8. At step 800, the approach is instigated prior to subsequent processing. At step 802 a type check is performed in relation to a document. This may be an external process. Alternatively the type can be defined in the document although in that case if it is incorrect then when the document is instantiated there may not be a type match. At step 804 the type is identified and declared for example from a comparison with the type options available. Where multiple options are available then the best match may be selected. At step 806, in subsequent processing the process is performed dependent on type matches. For example where a process requires a certain type for an input document or where a first input document requires a second input document to have a certain type the appropriate rule is applied to establish whether the process can be performed or whether the process should stop.

For example referring to FIG. 1, the template 104, may specify a certain data type for variable data 108, name 3 if they are to be combined. Alternatively, process P1 may specify that it requires, as input, a template type and a variable data type.

As a result an approach is provided that extends beyond a mere data check for example, to establish whether a field is populated in a data component to requiring the type of a document itself to be declared, for example establishing that a “style” component or a template is required.

Turning now to a fourth aspect in overview, which once again can be implemented in conjunction with one or all of the other aspects described herein, or implemented independently, the approach can be understood with reference to FIGS. 9 and 10. According to the fourth approach, when a variable data document is presented to the viewer for example after processing by an observer, editable elements in the display contain references to both their origin in the original source template and the editing operations or edit controls that can be performed on that element. This allows the viewer to perform the edit operations on the instance of the document produced by the observer from the template. The edit changes are applied automatically to the template itself. As a result the editing operations are decoupled from the details of how the variable data template is processed to produce specific instances of the document and can be configured to specific classes of documents.

Turning to FIG. 9, inputs to a process 900 includes one or more variable data documents 902a, 902b, a template document 904 and a further document 906 including a declaration concerning editability in the form an editable portion definition. The template 904 includes an editable portion 908 and upon processing of the documents process 900 outputs an output machine-readable document 910 including the data 902a, 902b and the editable portion 908, and carries the editable portion definition. When a user viewable presentation document 912 is produced by the observer 914, the user is able to edit the editable portion 908 according to the definition and any edit operations selected by the user are performed automatically on the template 904 at a template source location identified in the editable position definition, as discussed below.

Referring to FIG. 10, therefore, a method of constructing an editable machine-readable presentation document comprises, at step 1000, generating a document with editability by processing a template document and an editable portion definition (and variable data as appropriate). At step 1002 a machine-readable document is constructed including an identifiable portion. At step 1004 the viewer edits the document for example by moving a cursor over the editable portion and selecting, from the available options, a desired edit control. At step 1006 the edits are automatically applied to update the template.

The approach can be further understood with regard to the specific examples shown in FIGS. 11 and 12. FIG. 11a shows variable data document 902a, including, in the instance shown, data 1100. FIG. 11b shows an insurance claim template 904 including an editable portion 908 comprising a graphic 1102 having a certain size SIZE 1 and colour COLOUR 1. FIG. 11c shows an editable portion definition 906 including identification of the location of the editable portion and the edit controls applicable to the editable portion. Accordingly the location comprises, for example, the coordinates of the graphic 1102 in FIG. 11b and the controls comprise, for example, permissible variations of the size and colour of the graphic 1102.

When the template, 904, variable data 902a, 902b and editable portion definition 906 are processed and a viewable presentation document is produced for viewing by a viewer, the output document 1200 is shown in FIG. 12a as including the text 1100 and the graphic 1102. When, as shown in FIG. 12b, the user selects the graphic 1102 for example by drawing a cursor 1104 over it with a mouse, by virtue of the editable portion definition of the location this is identified as an editable portion and the editable portion controls 1202 are displayed as shown in FIG. 12c for example in the form of a drop down menu 1204. If, for example, the user selects SIZE 2 and COLOUR 4 from the available options then the template 904 is updated as shown in FIG. 12d so that the graphic has size 2 and colour 4 and, referring to FIG. 12e, the user viewable document 1200 is correspondingly updated.

As a result an improved approach is provided over existing approaches where the template must be edited directly. In such direct editing arrangements only limited editing is possible and without the ability to see immediately the effects on the output documents.

Turning now, in overview, to a fifth aspect which may be implemented in conjunction with one or more of the other aspects described herein or can be implemented independently, the approach can be understood with reference to FIGS. 13 and 14. According to this approach a method of constructing a remotely editable machine-readable document is achieved by sending both a presentation image of a machine-readable document—for example a user viewable form to be edited together with a data structure identifying editable portions, to a remote editing location. The data structure may be an editable portion definition of the kind described with regard to the fourth aspect or may take any other appropriate form. Selection of editable areas within the documents is achieved by superimposing visual cues over an image of a document page. The positioning of the cues is derived from the document source by marking those elements that are editable, carrying this information through to the document presentation and conveying the associated positioning information to the browser. This enables remote editing of the document source using a standard web browser without the need for special graphical support.

Referring in more detail to FIG. 13, at a remote source which may be, for example, a server designated generally at 1300, a presentation image 1302 and a data structure 1304 identifying editable portions of the presentation image are generated. The presentation image may be generated, for example, produced by an observer 1310 from input documents shown generally as components 1306, 1308. The presentation image 1302 and data structure 1304 are sent for example over a network such as the internet 1312 to a remote editing location 1314 which may be, for example, a client computer. The client computer receives and displays the presentation image 1302 and implements the data structure 1304 allowing identification editing of the editable portion.

Referring to FIG. 14a, therefore, the client computer may display the presentation image 1302 in conjunction with the edit screen 1304 of FIG. 14b indicating the edit controls available for an aspect of the presentation image when that aspect is highlighted. When the edit command is performed the information is returned, again under the control of the data structure, to the remote source 1300 according to a source location defined in the data structure where the document is updated and the revised image shown in FIG. 14c returned to the remote editing location together with the data structure allowing further editing.

Referring to FIG. 15, at the remote source or server, therefore, the presentation image and data structure are generated and at step 1502 these are sent to the remote editing location or client computer. At step 1504 the editable portion is edited and at step 1506 the edit is sent back to the server computer. At step 1508 the image is regenerated at the server and at step 1510 the edited image and data structure are sent to the client.

Hence a document that is constructed as an arrangement of pieces (for example images, text blocks, graphics) can be performed where a piece is selected before editing its content. This can be implemented remotely for example, for consumers or small business users where special local applications or web browser plug ins are not available to provide a suitable graphics environment for editing according to the aspect. Furthermore the service provider, for example at the server, can retain the documents source and code formatting a presentation from it without releasing it to the client.

Turning now to a sixth aspect in overview which can be implemented independently or in conjunction with, for example, the fifth aspect described above or any of the other aspects described herein, a method of controlling construction of a machine-readable document is provided. In particular a system is provided allowing users at a remote editing location to remotely manage their variable data and document templates via a web browser and selectively to create document instances for printing or other forms of distribution. The aspect combines template editing and flexible document layout techniques that can be accessed remotely to automate and simplify the overall process and allows, for example, addition of a data field at a remote editing location such that a corresponding machine-readable document template at a remote source is updated to include the additional data field.

The approach according to the sixth aspect can be further understood with reference to FIGS. 16 and 17a and 17b. Referring firstly to FIG. 16 the architecture of an appropriate system can be seen as including a server or remote source 1600 which stores both data 1602 and templates 1604. The server communicates with a web server 1606 which in turn communicates via a network 1608 for example the internet 1608 with a remote editing location 1610 which can be, for example, a business user's web browser. The web server 1606 allows uploading and editing of data including adding or deleting allowable fields, uploading example documents and conversion to templates, editing of templates including adding references to variable data, and selection of templates and data in generation of documents and deployment of documents.

The steps performed at the client or remote editing location are shown in FIG. 17a and the steps performed at the server or remote source are shown in FIG. 17b. The approach provides a method of controlling construction of a machine-readable document at a server from a client. Providing a remote view onto data from a web client can be performed using HTML forms or any other appropriate manner as will be well known to the skilled reader. A template and data are stored at the server and at step 1700 the client views a machine-readable document template or data at the server. Providing a remote view onto a template can be performed, for example, according to the approach described in the fifth aspect or in any other appropriate manner, At step 1702 the client sends change instructions to the server which may comprise or include add instructions for example by adding a reference to a newly added data field. Of course these steps can be performed in any order or simultaneously. The variable data document has at least one populated data field and the template has static and dynamic portions, the dynamic portions being processable in conjunction with the variable data machine-readable document to construct an output machine-readable document. Hence, for example, the at least one further data field is added by the user to the variable data machine-readable document and populated and the template or data is modified at the server according to the change instructions to include a dynamic portion corresponding to the added data field. This can be achieved, for example, using a data structure received from the server including an editable portion definition as described with reference to the fourth and fifth aspects, or in any other appropriate manner such as, once again, using HTML format. At step 1704 the client receives and displays the view of the modified data and/or modified document generated by the server by applying the template to the data, for example in the manner described above with reference to the fifth aspect.

At step 1706 therefore, the server receives the modified information and at step 1708 processes and updates its data and templates and provides a view of these once again at step 1710.

Still in overview, the approach according to the sixth aspect can be further understood with regard to the non-limiting example shown in FIG. 18. At a local server location 1800 a document template 1802 for example for a seminar flyer includes static data “Seminar” 1804 and “Venue: Town Hall” 1806 together with variable date data 1808 and variable speaker data 1810. Variable data documents 1812 include date data 1814 and speaker data 1816. The template is instantiated with the variable data to provide a user variable document 1822 of which a view is provided to the user.

According to the sixth aspect a variable data field is added in the form of converting the static “Venue: Town Hall” field to a variable or dynamic data field, together with the corresponding venue information for example using appropriate edit controls provided in an editable portion definition. Once the template has been modified to include the information as a dynamic portion and the data field has been populated by the user with the venue information corresponding instructions are returned to the server 1800 including an instruction to add the field to the variable data and an initial value for the field. In addition but not necessarily simultaneously, instructions are sent to modify the static venue field in the template that references the date. At the server the template is modified accordingly, the additional data added as a variable data field 1812 and the template and variable data bound to generate a result document. This document or an observation thereof is sent to the client 1820.

As a result of the described approach, a significantly less time consuming approach is provided for updating variable data documents based on templates that allow incorporating different data for each document generated, hence providing customisable or personalisable documents using a web based service and variable data document templates. In particular improved flexibility is provided by allowing addition and population of further data fields and modification of a remote template without requiring specialised software or servers.

Having discussed various aspects of the present approach in overview above, each aspect will now be described in more detail in relation to an exemplary and non-limiting approach.

Turning to the first aspect in more detail, a more generalised architecture for processing a modular variable document is shown in FIG. 19 for constructing documents of the type, for example, described above with reference to FIG. 6a in which it is desired to combine machine-readable documents such as template documents and variable data documents. The various modular parts can be reused to make different documents and a corresponding description can be the input to a tool for generating selected output documents, as discussed above. In particular it can be seen that machine-readable documents can be input to one or more processes, that multiple processes can be applied with further inputs, and that the output documents can be viewed in user viewable form via one or more observers at any appropriate point in the architecture.

FIG. 19 shows an architecture with processors 1900, 1902, 1904, 1906, 1908 and 1910 and observers 1912, 1914, 1916. Template documents 1918, 1920 are input to process 1900 and template documents 1920 and 1922 are input to process 1902. Of course these may also be other types of data documents such as variable data documents. A data document 1924 is output from process 1900 and a data document 1926 is output from process 1902. These documents are output documents from the processors but can also comprise input documents to further respective processors 1904, 1906.

A further variable data input 1928 comprising multiple documents is processed by process 1904 and multiple data documents 1930 are also processed by process 1906. The multiple output documents 1932 of process 1904 can be observed by an observer 1912 to provide user viewable documents 1934. The output documents 1932 from process 1904 also comprise inputs to process 1908 together with further multiple variable data documents 1936 to provide an output 1938. An observer 1914 allows presentation of user viewable documents corresponding to each of the input documents 1938. The output documents 1940 of process 1906 together with further data documents 1942 are input to process 1910 to provide outputs 1944 which can be viewed as user viewable output via observer 1916.

It will be appreciated that more than two inputs can be received by any process, of course. It will be further noted that where variable data documents comprise multiple variable data documents such as 1928 then respective multiple output documents 1932 are provided by the process. Similarly where multiple sets of variable data documents are input to a process such as 1932 or 1936 then the resulting process 1908 provides multiple outputs corresponding to each possible combination, i.e. the product of the number of input documents 1938.

As a result a notation is provided for describing a family of related documents where each document is defined in terms of a process applied to other documents in the family or, in the absence of such a process, is taken as an original input. For example document 1924 can be described in terms of the process 1900 and the input documents 1918, 1920. Document 1918 and 1920 themselves, which do not result from a process, are hence each taken as an original input with null process. In particular this can be achieved by assigning an identifier to the output machine-readable document identifying the storage location at which it is stored at that location. The identifier further identifies the names of the input documents to the process as well as the process itself. Hence an architecture such as that shown in FIG. 19 can be constructed derived from the information in the assigned identifiers to each document. As discussed below, this provides a fully modular approach allowing a complex process to be broken down into the elements shown in the architecture of FIG. 19 which in turn allows processing to be restricted to the components that have not already been completed.

Where a document comprises a set of instances, for example 1932 or 1938 in FIG. 19, the document is defined as the product of a number of such sets of data values, still identified by a single name having multiple instances. A generated document may be used as the input to another process for generating a further document and, as can be seen in FIG. 19, there is no limit to how many stages of processing may be used.

The manner in which the identifiers are assigned and used can be further understood with reference to the xml example set out below. Output document 1932 has an identifier “name 2” defining it and its associated process 1904. Input machine-readable template 1924 has identifier “name 1” in conjunction with its process 1900. Input variable data instance 1928 has identifier “name 3”. In the following example, therefore, the data files are declared, giving the name and location of the corresponding data. The process description is then declared, once again defining the location of name 2, the process applied and the inputs name 1 and name 3.

<!--DATA FILES-->
<doc id = “name 3”>

<location><datadir/>/name3.xml</location>

</doc>
<!--TEMPLATE FILES-->
<doc id: “name 1”>

<location><indir/>/name1.ddf</location>

</doc>
<!--PROCESS DESCRIPTION-->
<doc id= “name 2-ddf”>

<location><builddir/>/name2.ddf</location>
<process op=”ddf”>

<input><ref id= “name 1”/></input>
<data><ref id= “name 3”/></data>

</process>

</doc>

It will be noted that the manner in which the documents are processed can be in any appropriate fashion, for example that described in the above referenced document “Method of Processing a Publishable Document” whereby the machine-readable documents are treated as programs which can be compiled and executed by the processors to create a further machine-readable document and processed by the observers to create user viewable documents.

Because of the manner in which the architecture is described, a diagram can be generated of the overall application based on the use of one document as an input to the process that creates another. In addition it is possible to compute the processing steps needed to generate the document instances corresponding to given data and the dependencies that constrain the order in which processes may be performed. The processing can then be performed to generate a selected set of the possible instances that could be generated rather than, for example, running through every process and observer for every possibility, and in particular allowing suppressing of processing steps that correspond to documents that exist and are up to date.

This can be further understood with reference to FIG. 20. At step 2000 an appropriate viewer can construct a representation of the architecture for example as shown in FIG. 19 or the specific example of FIG. 1. This can be performed by any appropriate tool which can parse xml the declarations and construct the representation. At step 2002 the user can then select the desired components within the architecture. For example, reverting to the specific example of FIG. 1, the variable data 120 may comprise terms and conditions and it may decided that a user viewable document should be produced without this data.

At step 2004 the process is then implemented. Hence, for example, the template 104 in FIG. 1 may be bound with the variable data 108 by process P1 providing respective output documents 112a, 112b. These are then stored as instances against the corresponding identifier and, if appropriate, time stamped or otherwise marked with data signifying the “freshness” of the corresponding data. However it is not necessary to implement process P2 and so the observer 114 02 can be implemented to create user viewable documents 116a, 116b without the terms and conditions at step 2006. It will be seen that if it is desired to produce further instances at a later date then it is not necessary to re-run the process P1, but instead the data can be extracted using the identifier for the output (name 2) unless the time stamp shows that the data must be refreshed. Hence only those portions of the process that are stale require re-running to reproduce the output. Furthermore the approach allows multiple related outputs to be treated as families and the family relationship identified.

It will be appreciated that the first aspect can be implemented in any manner not limited to xml and can accommodate any number of input, output, template, data, style or other documents. Furthermore the documents can be processed by any appropriate process and the identifiers can take any appropriate form. The tool for viewing and implementing the process can be implemented in software as appropriate and the data can be stored and presented in user viewable form using any appropriate observer and format.

Turning now to the second aspect in more detail, a method for identifying an extractable portion of a source machine-readable document can be further understood with reference to the flow chart of FIG. 21. The approach can be understood in the context of the first aspect but can be implemented in any appropriate manner. According to the second aspect, as discussed above, input or output variable data documents can include components derived or extracted from source documents through a system of document fragment references carried through the construction process and only interpolated into final output forms.

Referring to the generalised example of FIG. 19, for example, a source document 1950 may have an extractable portion or fragment which is required by template document 1918. The template 1918 therefore retains a place holder or reference to the extractable portion in the form of an extractable portion identifier. Additionally or alternatively, the variable data to be instantiated during the process may have a reference to the extractable portion. In either event the various processes are applied to instantiate the variable data combined with other variable data templates in the manner described herein and the reference is carried unaltered through the process. For example where the reference 1954 appears in template 1918 then it will appear additionally in document 1924, documents 1932 and so fourth. When user viewable documents 1934 are produced by observer 1912 the reference is extracted from the source document 1950 as shown by arrow 1956. Hence the extractable portion fragment can be transported through arbitrary programs without requiring processing of it or risking degradation of the source data.

FIG. 21 shows an implementation of the approach according to the second aspect in the context of the insurance claim form example described above with reference to FIGS. 3, 6, 11 and 12. At step 2100 a completed application form with accompanying data is received. This is completed by the insuree and may include applicant data and other textual data in normally populated fields together with, for example, scanned-in images or other documentation for example in PDF form. At step 2102 proposal generation is commenced in which the data and the claim form template are combined. In addition the template may carry a reference to the scanned-in document for example pointing to a portion of the scanned-in document carrying photographs or hand-written notes relating to the claim. The reference is in a format recognised by the processing steps as being unalterable when the various components are processed at step 2104 which may comprise one or multiple processing steps. At step 2106 a user viewable document is generated including the portion of the original claim document identified by the reference, which is extracted from the source document. This may involve additional formatting steps if the user viewable document format is not the same as the source document format.

FIG. 22 shows schematically a possible form for the reference to the extractable portion as including a file name 2200 and location information within the file 2202. The file name can provide, for example, the location of the source document and, for example, the file type if this is not inherent through the context. The location information 2202 can identify the relevant portion of the identified file for example by page number or by a coordinate (x,y) position within the document together with width and height information or in any other manner. The reference is formatted such that it is identifiable as a reference and processed only at the point at which a user viewable document is created. This can be done, for example, by creating a Universal Resource Indicator (URI) in xml as a scalable vector graphic (svg) in the form: <svg:image width=“234” height=“345” type=“..” xlink:href=“filename” page-number=“2”

src-x=“..” src-y=“..” src-width=“...” src-height=“...”...>

It will be seen, therefore, that the gross properties “width” and “height” are defined together with the universal resource indicator “href” indicating the resource at “filename” and the extractable portion as defined by the page number, coordinate, width and height information and the src-x, src width etc. are the extractor information from the source as distinct from the placement in the final result document. Where the entire document is required then the extractable portion can be identified as the whole document.

Because, according to this format, the extractable portion comprises a separate part of the URI in addition to the resource name, less computation is required in finding and processing the portion as it is not necessary to interpret the URI. However in an alternative implementation the reference to the extractable portion can be included within the file name such that the entire construct comprises the universal resource indicator in the form:

File:///data/filename?page=...,x=...,y=...,width=..., height=...

In this instance the URI server would need to recognise and be able to parse its format.

Whichever format is adopted it will be seen that the relevant portion of the source document is defined externally such that no configuration of the source document itself is required.

As a result of the approach described in detail above with reference to the second aspect it will be seen, therefore, that the source document information cannot be corrupted during the processing of intermediate stages.

It will be appreciated that the second aspect can be implemented in any appropriate manner, relying on any source data and reference format as appropriate.

Turning now to the third aspect of the approach described herein in more detail it will be appreciated that this aspect can be implemented in conjunction with the other aspects described herein or independently thereof as appropriate. As described above, according to the third aspect, types are defined that can describe both the parts and the places into which they may fit in a composed document such that it can be verified whether documents and processors will be interoperable.

Once again the documents to which the aspect can be applied can be considered as functions that can be applied to data to generate the new documents which may themselves be functions. However the functional aspects must fit together several documents which are brought together for processing, as well as being matched to the data that is being incorporated. Otherwise the form of the output may be unintended but it may be hard to determine the problem from the output, especially if the output is used as an input to a subsequent processing step and does not exhibit the problem in an easily observable form. The third aspect provides a model for how the document pieces fit as well as tools which can determine directly whether or not the pieces fit to allow matched pieces to be detected early together with identification of the nature of the problem. The approach further allows selection of pieces having the required type from a repository of document pieces and the sorting of such a repository into common types. Furthermore it can be determined whether or not a document is of a given type, or the type can be inferred by inspection and the type of a composite document can be derived from the types of its parts. An appropriate tool can be implemented to allow these various steps.

The steps involved can be further understood with reference to the flow diagram of FIG. 23, and can be implemented by any appropriate tool. At step 2300 the document type is inspected for example by retrieving relevant aspects of the document, and at step 2302 the document type is determined. Where multiple candidate types are available then the type can be selected as the best match for example from a pre-calculated list of potential types. At step 2304 the appropriate steps are then performed dependent on the declared types. For example the process may be aborted if an inappropriate type is identified or further examination can be carried out to identify if there is a relationship between the types which allows other types to be used if the desired match is not made.

The approach provides advantages over conventional approaches whereby modular documents are simply imported wholly or partially into one another without any compatibility check for the pieces of the modular documents. By defining types, early detection that a document is not of the required type is possible, and specifications are provided against which a collection of reusable document components can be built. Type checking of the compatibility of the pieces being combined provides better information regarding incompatibilities and reduces the need to work backwards from observed defects in the final output.

It will be appreciated that the third aspect can be implemented in any appropriate manner for example not limited to xml. The type can be declared in the input or process and can be assessed in the input or process or using an external tool as appropriate. The type can be obtained, for example, by checking it against a pre-calculated type list or using any appropriate algorithm for both type selection and best match selection.

Turning in more detail to the fourth aspect which once again can be implemented independently of, or in conjunction with one or more of the other aspects as described herein, the operation can be understood with reference to FIG. 24. In particular FIG. 24 shows how editable elements in a displayed user viewable output containing references to their origin in the original source template and the editing operations that can be performed on that element can be implemented allowing automatic update of the template.

At step 2400 the edibility can be defined by creating an edibility declaration or document setting out the patterns of elements for which a particular editing operation is valid in a source document such as a template or variable data document, an extractor program or function which can be applied to the selected item to determine the current value of the property being edited and an effector program to which a new value for the property can be used as an argument. The pattern, extractor and effector for a given desired editing operation can be packed together as a declaration and, as described below, projected automatically into the necessary programs sections within the presentation generator or observer and editing interface.

At step 2402, an output or user viewable document is generated. For example a source document is transformed into a presentation with interpolation of variable data. The source document may be a template which need not itself be presentable and which may contain complex programmatic constructs such as iterations, selection and choice which are evaluated when the source document is bound to specific values of variables. At step 2404, during this transformation, presentation elements which can be edited are annotated with a reference to their origin within the source and the permissible editing operations or controls on this element. The result is a viewable document that contains enough information buried within it that the original source can be altered selectively. In particular the description of edibility on the document describes patterns of elements for which a particular editing operation is valid. Annotations are added to elements that meet this pattern, which can vary according to the editing capabilities required. For example only images that meet particular criteria (larger than the given size for example) might be editable or text in particular with classes (main body) might not be permitted to have their fonts style edited, whereas other “free” text can be editable and with have the annotation added. The patterns may be guarded to ensure that they only apply to documents which they are intended, for example by incorporating a reference within the pattern to the identities or types of documents in relation to which they are useable.

At step 2406, when editing the document, the document instance is displayed in an editing viewer which can interpret the editing annotations within the presentation. At step 2408, when the user selects a particular element on the screen (for example by dragging a cursor over the element) such as a text block, picture or graphical element, at step 2410 any corresponding annotation is recognized and, at step 2412, appropriate controls for performing the edit are retrieved from the annotation and generated by the editing viewer to display the appropriate set of controls. These controls can include, for example, the current value of the various editable aspects together with the available changes that can be made. The current values can be obtained by the extractor program attached to the editing control, and the current values can be any appropriate form for example a simple scalar such as a dimension or a font or a colour, or a compound property such as an aspect ratio which can be calculated from other properties or even a variable binding itself having a programmatic sense. Display of the current value and new possible values can be in any appropriate manner for example a standard user-interface selector and can be declared in the annotation along with the other controls or can be calculated from context as appropriate.

At step 2414, once the user, via the user-interface selector, has determined a new value for the property, this value is used as an argument to the effector program attached to the control, together with the reference origin in the source that generated the element being edited. The effector program then modifies the source, for example the template, at the indicator point to change it such that on reprocessing with the same variable data the displayed property is changed according to the user selected edit.

The annotation or editable portion definition can be included in a source document such as a template or separately as appropriate and can be in a form suitable to be recognised by the editing viewer or program to display the relevant controls. This allows edibility to be expressed in a single definition which can be varied between the documents to which it can be applied. The declaration can be, for example, expressed in xml identifying the editable portion (for example “circle”) the applicable controls (“control”) and the location in the source (“path”) providing all relevant information to the editor. For example the declaration may take the form, in this specific example:

<svg: circle r=243

edit:controls= “c1 control

colour control”

edit:path= “page/svg[4]/circle>

It will be seen that editing can proceed by four distinct steps:
i) an edit definition declares what should be editable, what types of editing may be performed on such items and how to alter such an item to make the editing changes chosen in the form of the editing effector program, which, given an item to edit and ‘choice’ parameters setting out the modifications, will produce a new item to replace the original.
ii) this definition is used to arrange that for the editable items generated from the template all will be annotated or “decorated” with this editability (usually in the form of references to controls) and references to source locations where an item came from in the template. As discussed above, any process passes both these forms of reference through untouched, up to the final views.
iii) a minimal view-editing program can process cases of selecting items with such decorations (for example with mouse-over), arranging for appropriate controls to be displayed and supporting interaction—this could be any of several mechanisms which will be well known to the skilled reader (java in a dedicated editor, javascript in a browser, client-server and so forth.) Eventually an edit action (e.g. Apply) is selected.
iv) once “Apply” is selected the edit effector program(s) identified above and associated with the employed control(s) is then applied to the source template location with the newly chosen parameters and the result is a new ‘item’ (which actually could be a possibly-null sequence of pieces) to replace the original in the template. This program can be described in any appropriate manner, but in one approach, technically it is treated as a parametric function of the original item, for example as XSLT (XML-processing) programs. The program can be held anywhere (even attached to the element itself in the view), for example it can be held in the server associated with the ‘name’ of a control, all of which are derived from the original edit definition.

As a result of this approach an improved editing approach is provided whereby the template can be automatically updated and where, because the edibility declaration is defined in a single declaration, it can easily be located. The editor does not need to know anything about how the presentation was constructed from the source such that a generic editor can be built that can support the authoring and the modification of complex variable data documents. Furthermore the editor can be robust to changes in technology used for interpolation and layouts. The author or user can edit variable data documents or bound instances of the document and have effect on the actual templates and, by using different edibility mappings, document-class-specific editing can be supported within a single framework. This is advantageous in instances where processors involve different authors and workflows on the same underlying system.

The approach according to the fourth aspect can be implemented in any appropriate manner, the annotation can be constructed in any suitable form and the editor similarly can take any appropriate form.

Turning now to the fifth aspect of the approach described herein this can be understood with reference to the example structure shown in FIG. 25 and the flow diagram shown in FIG. 26. Once again the fifth aspect can be implemented independently of the other aspects described herein or in conjunction with one or more of those aspects as appropriate to allow remote document editing at a browser without the need for special graphical support.

Referring firstly to FIG. 25, at a server location 2500 a presentation image 2502 and a data structure 2504 identifying editable portions of the presentation image are generated from a source document 2506. In addition an instruction set expressing how to present the editable portions and how to display the options is stored at 2508 for example in javascript or another language readable at the client and which can be statically or dynamically generated. The server 2500 communicates for example by a network 2510 which can be the internet with a client location 2512 comprising a remote editing location. The presentation image is displayed at the client at 2514. In addition the data structure 2504 is received and interpreted by the client browser according to the browser readable instructions 2508. In particular the data structure 2504 indicates the portions of the presentation image that are editable, the available operations for editing and the subsequent editing steps such as returning the edit information to the server as discussed below.

FIG. 26 in particular illustrates the steps performed at the server acting as a remote source and client acting as a remote editing location. At step 2600 the server generates an image of the presentation for sending to the client web browser and at step 2602 a data structure indicating the pieces that can be edited, their position within the image and the editing actions that can be applied to them is also generated at the server. This data structure may, for example, correspond to the editable portion definition or annotations described above with reference to the fourth aspect. At step 2604 the presentation image and data structure are sent to the client. In addition implementation information in the form, for example, of javascript, indicating how to interpret the data structure, is also sent.

At the client, at step 2606 the image, data structure and implementation information are received and at step 2608 the document image is displayed by the client web browser at step 2610, using the information in the data structure interpreted according to the script. Areas of the image that corresponds to editable document pieces are made sensitive to user interaction such as moving the mouse over the areas. Such areas may be indicated by highlighting them in some way, for example surrounding them with a coloured box or overlaying with a colour or texture. This allows the user to identify and select a specific piece of the document to edit. The area of a selected piece may be highlighted using a different visual effect.

At step 2612, once a piece has been selected, the data structure may be used to identify what editing operations may be possible on the piece. For example if the piece is text, the text content may be changed, or its style (font family, font size, colour etc) may be changed. The available edit options are displayed to the user again in a similar manner, according to one embodiment, to the approach described in the fourth aspect above. At step 2614 the user edit is received at the client and at step 2616 the edit, that is, the parameters provided by the user for the editing operation such as new content or style is submitted by the client to the server using another data structure defined within the received data structure, including a reference to the piece or pieces to be edited. At step 2618 the server receives from the client the edit information and at step 2620 applies the edit to the document source. The server then returns to step 2600, generating a new presentation, image and data structure and sending them to the client so that the results of the edit can be made visible.

It will be noted that during the interactions at the client, and in particular steps 2612 to 2616, the identification of editable portions and the corresponding edit controls can be received in separate interactions. According to this approach, the server first sends the image and data structure to the client, the data structure simply indicating editable portions. Once the client has identified the portions requiring editing it can request edit controls from the server and display these once they are received. This introduces a lower security risk but increases latency on the clients side.

The approach described above allows rich editing facilities to be provided at a remote location and implemented on standard web browsers without requiring specific plug-ins to be installed to allow the level of graphical interaction provided according to the fifth aspect. Furthermore the document source can be kept secure on the server as well as the means of generating a document presentation from the source.

The fifth aspect can be implemented in any appropriate manner, the image and data structure expressed in any appropriate form and interpreted in any appropriate manner on the client using javascript or any other script or language implementable on a web browser to interpret the data structure.

Turning now to the sixth aspect of the approach described herein, once again this can be implemented independently of the other aspects or can be implemented in conjunction with one or more of those aspects to provide a method of creating customised marketing documents at a client location (remote editing location) such that a source or template document at a server location (remote source) can be similarly updated.

Referring to the flow diagram of FIG. 27, at step 2700, a document is viewed from the server. This includes data (such as text and images) to be used as variable document content and which may include fields that are predefined by the system. In addition the user can add fields to or remove fields from the variable data and can edit the values contained in the data field. The data may include, for example, information about a business including its contact information, sales staff, products or services as well as information about customers or potential customers or of course can be in any other appropriate form. The user can also view an existing example document for example, containing existing fixed content, style and layout and have it converted at the server into a document template. This conversion can be applied in any appropriate manner and the document may include examples of existing marketing documents such as brochures, leaflets, postcards or flyers. As a result, at the user or client end a presentation of a template and corresponding data are available.

At step 2702 the user can edit the template to modify the content, style or layout of the documents which the user can generate, or to add references to variable data fields into the template. For example this can comprise remotely modifying the template to introduce a reference to extended data in the template and to select a fixed part and make it modifiable to create a customised document. In addition the user may select a template and some subset of the existing data and generate a set of documents. Specific data will be embedded into a generated document whenever there is a variable data reference in the template. The generated document will be styled and laid out according to the definitions included in the template in any appropriate manner. Where the template is modified, then at step 2704 the template is modified at source for example adopting the approach as described in the fourth and fifth aspect above or in any other appropriate manner, and the updated template is viewed for approval or otherwise at the client. At step 2706 the final documents are generated and can be deployed in various ways, for example by being e-mailed directly to the recipient or being printed and delivered by direct mail to the recipient or being placed on a website for the recipient to collect or in any other appropriate manner.

The additional data field and template modification can be achieved in any appropriate manner, for example ‘variablisation’—to either create a new field (usually textual) or select one of the existing static fields (from an example-generated template perhaps) and turn its value into a dynamic one. To do this the approach is in the same manner as for changing the static text or any other property—through edibility definitions an editing control/option is attached to that element in the template which would pass through to the view. When the user selects this part in the view a suitable extra control is displayed (for example through javascript or via client-server interaction) which gives the possibility of making the value bound dynamically. If this is so chosen an edit effector is then deployed which alters the original template such that the reprocessed document-and-view will show the result, the effecting of the edit happening server-side.

It will be seen that according to this approach, at the client end no additional software or data management system is required, and that business and customer data, templates and document generation capabilities are accessible from any web browser allowing simple creation of a personalised marketing campaign by selecting a document template, the products or services to be featured in it and a subset of the customers to receive the personalised documents. Of course any other implementation can also be contemplated for the approach described above with reference to the sixth aspect.

It will be appreciated that the approach described according to the sixth aspect can be implemented in any appropriate manner for example using xml and javascript or any other appropriate language and implemented on any web browser, the suitable server end support.

The steps and approach described with respect to each of the first to sixth aspects can be implemented in software or hardware as appropriate.

Referring to FIG. 28 a server designated generally 2800 can include a processor component 2802 arranged to retrieve document components such as variable data and template documents, process such documents, including instantiating data, act as document observer and template updater as well as type check as appropriate. A data store 2804 can store, for example, the documents and instances thereof as identified by appropriate identifiers, templates and variable data, data structures and type check lists or algorithms as appropriate. A display 2806, for example a visual display can interact with the memory store and data structure to allow the user to view a complex process architecture and where appropriate, select identifiers relating to components of the architecture to be implemented for document processing.

The server 2800 can further include an input port 2810 for receiving remote client data for example relating to template modifications as well as an output port 2812 for sending to the remote location image presentations, data structures, implementing scripts and so fourth.

The server 2800 interacts remotely for example via a network 2814 such as the internet, and using any standard communication protocol with a client entity 2816 which can be, for example, a standard PC or any other appropriate computer apparatus including a processor 2818 which can, for example, process template data and editing controls. The client computer 2816 further includes a data store 2820 for example template documents, variable data documents and variable data. The client computer 2816 further includes a display 2822 for example for displaying image presentations and edit controls, an input port 2824 for receiving presentation images, corresponding data structures and so forth and an output port 2826 for forwarding template edits to the server 2800. In both the client and server computer, the various specific modules such as processor modules, storage modules, display modules, input and output modules may be of any appropriate form as will be well known to the skilled person such that a detailed description is not required here.

It will be appreciated that any appropriate programming approach can be adopted for implementing these steps described in the various aspects above and that the steps can be implemented in any appropriate manner and order as appropriate.

1. A method of controlling construction, at a remote source, of a machine-readable document comprising the steps of:
presenting a view of a machine-readable document template stored at the remote source and having static and dynamic portions, the dynamic portions being processable in conjunction with a variable data machine-readable document to construct an output machine-readable document;
presenting a view of a variable data machine-readable document stored at the remote source;
adding at least one data field to the variable data document;
populating the data field with data; and
sending an instruction to the remote source to modify the machine-readable document template to include a dynamic portion corresponding to the added data field.

2. A method as claimed in claim 1 further comprising sending, as an instruction, modification information relating to the modification of said machine-readable document template to the remote source.

3. A method as claimed in claim 1 further comprising processing the modified machine-readable document template in conjunction with the variable data machine-readable document to construct an output machine-readable document and creating one of a physical or electronic document form.

4. A method of controlling construction, at a remote source, of a machine-readable template document comprising the steps of:
receiving modification information relating to the machine-readable template document including an instruction to include a dynamic portion corresponding to an added data field; and
modifying the template document according to the modification information.

5. A computer readable medium containing instructions arranged to operate a processor to implement the method of claim 1.

6. An apparatus for controlling construction of a machine-readable document comprising a processor configured to operate under instructions contained in the computer readable medium to implement the method of claim 1.

7. An apparatus for controlling construction, at a remote source, of a machine-readable document comprising:
a processor arranged to present a view of a machine-readable document template stored at the remote source and having static and dynamic portions, the dynamic portions being processable in conjunction with a variable data machine-readable document to construct an output machine-readable document;
the processor further being arranged to present a view of a variable data machine-readable document stored at the remote source;
the processor further being arranged to add at least one data field to the document and populate the data field with data according to a user instruction;
the processor further being arranged to send an instruction to the remote source to modify the machine-readable document template to include a dynamic portion corresponding to the further data field.
